(19) United States
(12) Patent Application Publication
(10) Pub. No.: US 2006/0146009 A1
(43) Pub. Date: Jul. 6, 2006

(54) Image control

(76) Inventors: Hanno Syrbe, Weidenstetten (DE); Klaus Krischeu, Tomerdingen (DE); Rami Arto Koivunen, Turku (FI); Bartholomeus Gerardus Gosewinu Van Walstijn, Copenhagen (DK)

Correspondence Address: PERMAN & GREEN, 425 POST ROAD, FAIRFIELD, CT, 06824, US

(21) Appl. No.: 10/540,052

(22) PCT Filed: Jan. 22, 2003
(86) PCT No.: PCT/EP03/00607

§ 371 Date: Feb. 13, 2006

(51) Int. Cl. G09G 5/00

(52) U.S. Cl. 345/156

(57) ABSTRACT

The present invention relates to the field of hand-held devices that are equipped wit a processor and a digital camera for capturing motion video or still images. Images captured by the camera are used to determine motion of the hand-held device. A resulting motion signal is used as input to a user interface. Displayed images can be scrolled, zoomed or rotated by moving the hand-held device. The motion signal can also be used as input for graphical user interface to move a cursor or other object of the graphical user interface over the display. The invention relates further to a hand-held device provided with means for sensing motion, a display, a keypad with at least a first- and a second key, and a graphical user interface with objects and a cursor. The hand-held device also includes means for transforming the sensed motion of the handheld device into a signal suitable for moving the cursor over the display.

The present invention relates to the field of hand-held devices that are equipped with a processor and a digital camera for capturing motion video or still images, in particular such devices that further comprise a display for displaying images or a graphical or character based user interface.

### BACKGROUND ART

Hand-held devices provided with digital image capturing equipment, digital processing power and high resolution displays are becoming increasingly more common in a wide variety of uses.

For example, small mobile phones are recently being equipped with digital cameras and relatively small high resolution LCD screens. Hand-held computers commonly called “personal digital assistants” (PDA) are also available and are typically equipped with small high resolution display screens and have slots for receiving e.g. a digital camera. Similarly, communicators having both cellular communication and computer capabilities are available, typically having small display screens and an inbuilt or detachable digital camera. These small, hand-held devices do not, and cannot, conveniently have conventional input devices, such as a computer mouse and other control keys. Therefore, conventional personal computer interfaces, which also have their own drawbacks, are not suited for these small hand-held devices.

As a result, there are significant limitations on using such small hand-held devices in both obtaining output, e.g. viewing data on the display screen, and in inputting commands, e.g. changing the area viewed on the display screen or controlling the performance of a particular parameter associated with the device. Further, given the limited area available, not only on the display screen but also on the entire device, adding additional control keys, etc., is both difficult and burdensome to a user requiring two hand operation of the device.

U.S. Pat. No. 6,466,198 discloses a system and method for view navigation and magnification of the display of hand-held devices in response to the orientation changes along only two axes of rotation as measured by sensors inside the devices. The view navigation system can be engaged and controlled by simultaneously pressing switches on both sides of the hand-held device. Miniature sensors like accelerometers, tilt sensors, or magneto-resistive direction sensors sense the orientation changes. These miniature sensors are presently not typically standard equipment for hand-held devices. Thus, such sensors add cost, use precious space and add weight.

The present invention is directed toward overcoming one or more of the above-identified problems.

### DISCLOSURE OF THE INVENTION

On this background, it is an object of the present invention to provide a hand-held device of the kind referred to initially, which allows user input with the same hand that holds the device, without requiring the dedicated sensatory equipment used by prior art hand-held devices.

This object is achieved in accordance with claim 1, by providing a hand-held device comprising: a processor, a display, a digital camera for capturing motion video or still images, means for presenting still images or motion video captured by said digital camera on said display; means for transforming a signal from the camera into a motion signal indicative of the motion of the hand-held device; and a user interface in which motion of the hand-held device is—through the motion signal derived thereof—used as a user input to control operation of the hand-held device.

Thus, by using a sensor that is available to start with in many hand-held devices—namely a digital camera—for a secondary use, namely creating a motion signal indicative of the motion of the hand-held device, a hand-held device with motion sensing is provided in a economical and reliable manner.

The hand-held device may further comprise a user interface in which motion of the hand-held device is—through the motion signal derived thereof—used as a user input.

The hand-held may further comprise a display, preferably a display suitable for displaying captured images.

Motion of a given type of the hand-held device can be used to manipulate images shown at least in part on the display, preferably by moving the images in a manner substantially corresponding to the movement of the hand-held device.

Different types of motion the hand-held device can e.g. be used to move, and/or zoom, and/or expand/collapse and/or rotate images displayed on the display.

Motion substantially parallel to the plane of the display of the hand-held device can be used to scroll an image displayed on the display. Motion substantially perpendicular to the plane of the display can be used to zoom an image displayed on the display. Rotational motion of the hand-held device can be used to rotate an image displayed on the display.

The images that are manipulated can e.g. be images that were previously captured by the camera.

The movement of image can be inverted with respect to motion of the hand-held device, since some users may prefer this.

The user interface may comprise a graphical user interface and motion of the band-held device can be used as an input to the graphical user interface.

Motion of the hand-held device can be used to manipulate an object displayed by the graphical user interface, preferably by moving the object in a manner substantially corresponding to the motion or to the inverted motion of the hand-held device, whereby the object displayed by the graphical user interface can be an icon, a dialogue box, a window, a menu or a pointer.

Motion of a given type of the band-held device can be used to move, and/or zoom, and/or expand/collapse and/or rotate objects displayed by the graphical user interface.

Motion substantially parallel to the plane of the display of the hand-held device can be used to scroll an object displayed by the graphical user interface. Motion substantially perpendicular to the plane of the display can be used to zoom an object displayed by the graphical user interface. Rotational motion of the hand-held device can be used to rotate an object displayed by the graphical user interface.

The digital camera can be an inbuilt camera or can be a detachable camera. The camera may be movable relative to the hand-held device.

The means for transforming a signal from the camera into a motion signal preferably derives the motion signal from changes between succeeding images captured by the camera.

The camera can be equipped with an autofocus system, whereby the focusing setting of the autofocus system can be used for detecting movement in the camera direction.

The hand-held, device may further comprise at least one key. The functionality of a motion type can be dependent on the state of the at least one key.

Rotational motion of the hand-held device about an axis substantially perpendicular to the display may be used to cause an inverse rotational movement of the image or graphical user interface object relative to the display, preferably in a manner such that the image or object is static with respect to the fixed coordinate system in which the hand-held device is situated.

The motion signal can be used to adjust device settings, such as sound settings, keypad settings and display settings.

The hand-held device may further comprise a keypad with at least a first and a second key and the graphical user interface comprising a cursor, whereby motion of the hand-held device can be used to position the cursor over an object of the graphical user interface and primary functions associated with the object concerned can be activated by pressing the first key and secondary functions associated with the object of the concerned can be activated by pressing the second key.

The functionality of the first key can be associated with selection and activation of objects of the graphical user interface, and the functionality of the second key can be associated with calling up a context-sensitive menu.

The selection of the object concerned can be performed by pressing and releasing the first key. Activation of the object concerned can be performed by pressing and releasing the first key twice in rapid succession. Moving or resizing of the object concerned can be performed by holding down the first key while moving the Hand-held device to move the cursor.

The first key and the second key can be softkeys, whereby the current functionality of the softkeys is shown in the display, preferably in dedicated fields of the display.

The first key can be placed below the display on the left side of the latter, preferably proximate to lower edge of the display, and the second key can be placed below the display on the right side of the latter, preferably proximate to lower edge of the display.

It is another object of the present invention to provide an improved method for proving user input to hand-held devices. This object is achieved by providing a method for creating user input for a hand-held device that has a processor, a user interface and a digital camera for capturing motion video or still images comprising the steps of: obtaining a camera signal, alternatingly using the camera signal to capture still images or motion video; or to determine motion of the hand-held device from the camera signal; and using the determined motion of the hand-held device as an input for the user interface.

It is yet another object of the present invention to provide a use of a digital camera of a hand-held device that has a processor to produce a motion signal indicative of motion of the hand-held device.

A further object of the invention is to provide a hand-held device with an improved graphical user interface. This object is achieved by providing a hand-held device comprising a processor, means for sensing motion of the hand-held device, a display, a keypad with at least a first- and a second key, a graphical user interface with objects and a cursor, and means for transforming the sensed motion of the handheld device into a signal suitable for moving the cursor over the display.

By controlling the position of a cursor through motion of the handheld device it becomes possible to provide a user-friendly cursor controlled graphical user interface for hand-held devices.

Preferably, motion of the hand-held device is used to position the cursor over objects of the graphical user interface and primary functions associated with the object concerned are activated by pressing the first key and secondary functions associated with the object concerned are activated by pressing the second key.

The functionality of the first key can be associated with selection and activation of objects of the graphical user interface, and the functionality of the second key can be preferably associated with calling up a context-sensitive menu.

Selection of the object concerned is preferably performed by pressing and releasing the first key, and activation of the object concerned is preferably performed by pressing and releasing the first key twice in rapid succession.

Moving or resizing of the object concerned can be performed by holding down the first key while moving the hand-held device to move the cursor and the object concerned in unison therewith.

The first key and the second key can be softkeys, whereby the current functionality of the softkeys is shown in the display, preferably in dedicated fields of the display.

The first key can be placed below the display on the left side of the latter, preferably proximate to lower edge of the display, and the second key can be placed below the display on the right side of the latter, preferably proximate to lower edge of the display.

The means for transforming motion of the handheld device into a signal suitable for moving the cursor over the display may further comprise a tilt sensor and/or an image capturing device and/or an accelerometer.

The hand-held device according may further comprise means to transform a signal from the image capturing device, i.e. camera and/or tilt sensor and/or accelerometer into a position signal for the cursor.

The means for transforming a signal from the camera into a motion signal preferably derives the motion signal from changes between succeeding images, or parts of succeeding images captured by the camera.

The camera may have an autofocus system, whereby the focusing setting of the autofocus system is used for detecting movement in the camera direction.

The graphical user interface may include one or more of the following object types: icons, dialogue boxes, windows, menus, pointers.

Further objects, features, advantages and properties of the hand-held device, method for proving user input and use of a digital camera in a hand-held device according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 illustrates a preferred embodiment of a hand-held device according to the invention,

FIG. 2 shows a block diagram of the hand-held device of the embodiment of FIG. 1,

FIG. 3 indicates the axes of movement and rotation along which the hand-held device is moved and rotated in order to create user input in accordance with the present invention,

FIGS. 3.1 to 3.7 illustrate the use of the present invention for zooming, scrolling and rotating images shown on the display,

FIGS. 3.8 to 3.10 illustrate the use of the present invention for user input to a graphical user interface to scroll a table in a window and to resize a window,

FIGS. 3.11 to 3.13 illustrate the use of the present invention for scrolling a magnifying window over the display,

FIGS. 3.14 and 3.15 illustrate the use of the present invention for moving a part of an image by cutting an pasting,

FIG. 3.16 illustrates the use of the present invention with a text editing application,

FIG. 3.17 illustrates the use of the present invention with an application for entering musical notes in a stave,

FIG. 3.18 illustrates the use of the present invention with a labyrinth game

FIG. 3.19 illustrates the use of the present invention for controlling a video game,

FIG. 3.20 illustrates the use of the present invention with an application for controlling the sound settings of a music player funtion,

FIG. 4 outlines a software flow diagram for zooming, scrolling and rotating images shown on the display, and

FIGS. 5 and 6 show an alternative preferred embodiment of a hand-held device according to the invention.

### DETAILED DESCRIPTION

This invention allows hand-held communication or computing devices with a relatively small display to receive user input by moving or rotating the device. In particular with devices having a display, the invention allows convenient navigation of a large stored virtual display or of objects in a graphical user interface. Such devices may include PDA devices, camcorders, digital photo cameras, digital binoculars (solid-state stereoscopic imaging system incorporated for viewing and digitally recording magnified stereo images), mobile hand-held terminals, advanced pagers, mobile telephones, and communicators.

According to a preferred embodiment, the hand-held device is a hand portable phone, preferably a cellular/mobile phone.

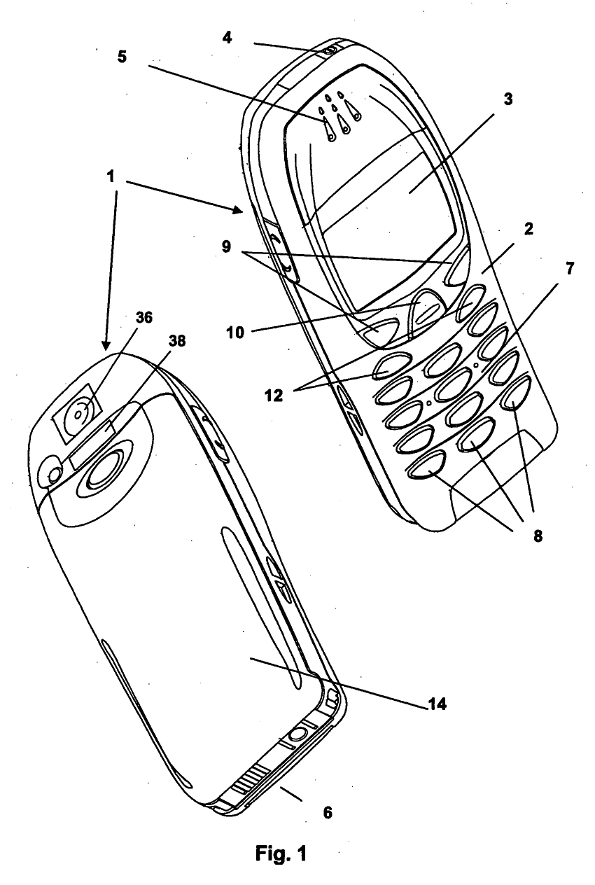

FIG. 1 shows a mobile phone according to the invention, and it will be seen that the phone, which is generally designated by 1, comprises a user interface having a keypad 2, a display 3, an on/off button 4, a speaker 5 (only the openings are shown), and a microphone 6 (only the opening is shown). The phone 1 according to the preferred embodiment is adapted for communication via a cellular network, such as the GSM 900/1800 MHz network.

The keypad 7 has a first group of keys 8 as alphanumeric keys, by means of which the user can enter a telephone number, write a text message (SMS), write a name (associated with the phone number), etc. Each of the twelve alphanumeric keys 8 is provided with a figure “0-9” or a sign “#” or “*”, respectively. In alpha mode each key is associated with a number of letters and special signs used in the text editing.

The keypad 7 additionally comprises two softkeys 9, two call handling keys 12, and an arrow key 10. The function of the softkeys depends on the state of the phone and the navigation in the menu can be performed by using the navigation-key. The present function of the softkeys 9 is shown in separate fields in the display 3, just above keys 9. The two call handling keys 12 are used for establishing a call or a conference call, terminating a call or rejecting an incoming call. This key layout is characteristic for e.g. the Nokia 6210™ phone.

The arrow key 10 is an up/down key which can be used for cursor movement and scrolling and is placed centrally on the front surface of the phone between the display 3 and the group of alphanumeric keys 7. A battery pack 14 is mounted on the back of the phone and supplies electrical power for the electronic components of the mobile phone.

The phone has a flat display 3 that is typically made of a LCD with optional back lighting, such as a TFT matrix capable of displaying color images.

The phone is equipped with a digital camera 35 of which only the lens 36 is visible in FIG. 1. The camera is arranged at the rear of the phone above the battery pack 14. The camera direction is therefore substantially perpendicular to the rear surface of the phone 1. Just under the camera an infrared port 38 for IrDA communication is provided (only window of the port is shown). The camera may alternatively have a rotatable connection to the phone (not shown), to allow adjustment of the camera direction relative to the housing of the phone.

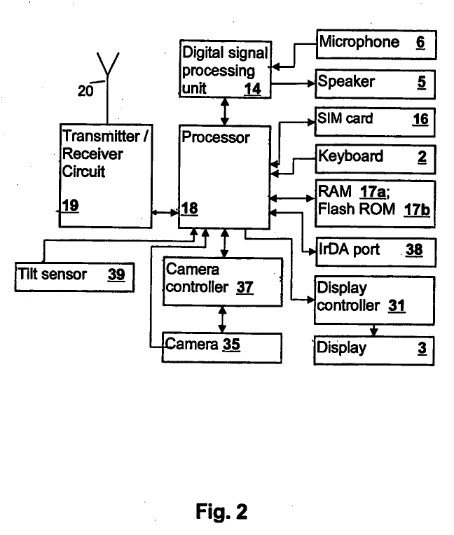

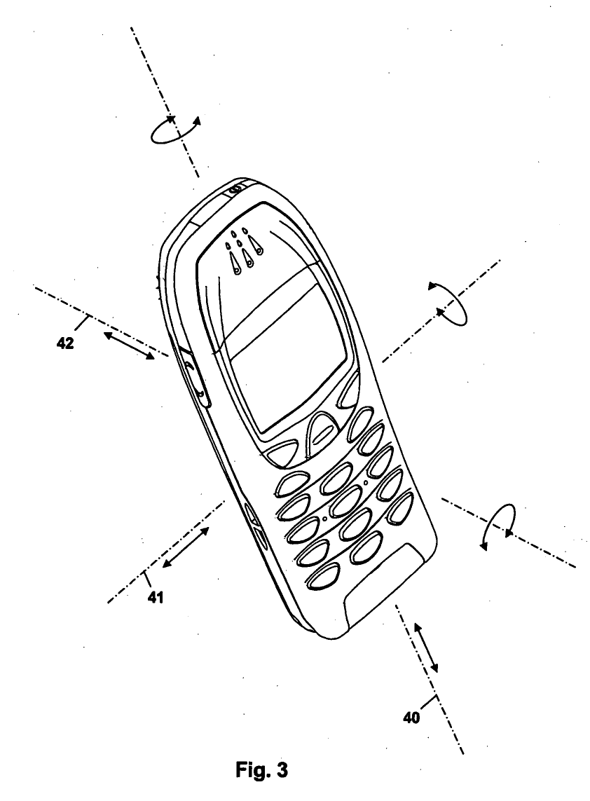

FIG. 2 schematically shows the most important parts of a preferred embodiment of the phone, in the form of a block diagram. A processor 18 controls the communication with the network via the transmitter/receiver circuit 19 and an internal antenna 20. A microphone 6 transforms the user's speech into analogue signals, the analogue signals formed thereby are A/D converted in an A/D converter (not shown) before the speech is encoded in a digital signal processing unit 14 (DSP). The encoded speech signal is transferred to the processor 18, which i.e. supports the GSM terminal software. The processor 18 also forms the interface to the peripheral units of the apparatus, including a RAM memory 17a and a Flash ROM memory 17b, a SIM card 16, and the keypad 2 (as well as data, power supply, etc.). The digital signal-processing unit 14 speech-decodes the signal, which is transferred from the processor 18 to the earpiece 5 via a D/A converter (not shown). The processor communicates in two directions with the IrDA port 38 (infrared port) that allows data communication with other devices that are equipped with such a port, such a PC's, laptops, personal digital assistants (PDA) and other mobile phones. The phone may further be equipped with a short range RF transmitter receiver (not shown), e.g. according to the Bluetooth standard, for data transmission with other devices as mentioned for IR data communication.

The processor 18 also forms the interface for the display controller 31. The image controller 31 receives the image files from the processor 18 and renders images for showing on the display 3.

A camera controller 37 is also connected to the processor 18 and controls the digital camera 35. The camera controller 37 sets the resolution, the refresh rate, the focus, and zoom factor of the camera 35. The camera controller 37 sets the focus automatically through any of the well-known auto focus techniques available. The output signal of the camera 35 is connected to the processor 18.

When the camera is used to detect motion of the hand-held device, the camera controller 37 automatically selects the appropriate resolution and refresh rate, so that the refresh rate is high enough to derive a smooth motion signal from the changes in the succeeding images. For motion detection it is not usually necessary to use the complete image captured by the digital camera. The software can pick out a particular section of the image for the motion detection so that the amount of data that has to be processed is reduced. These two measures (low resolution and using a section of the image) allow higher sampling rates and reduced power consumption because of lower data processing power demands.

Some surfaces in the camera view may not be particularly suited for detecting motion, e.g. because of a uniform surface, or because the distance to the objects in the camera view is too large to determine changes in distance accurately. Such problems may be solved (in the embodiment with the adjustable camera direction) by directing the camera to another available object with sufficient texture, such as the user. The camera direction is thus reversed compared to the “normal” direction. The motion signal derived from the camera signal is therefore automatically inversed when the camera is directed to the user.

The camera 35 is a conventional digital camera and therefore not all the features of the camera 35 are shown. The image sensor of the digital camera can be any of the known configurations for solid-state image sensors, such as frame transfer, interline transfer CCDs, or diode arrays.

Standard CCD devices are sensitive to both visual light and near infrared light. Conventional digital cameras for capturing images with visual light are therefore provided with an infrared filter for preventing influences of infrared light on the captured image. The mobile phone 1 is also provided with an infrared filter (not shown). The infrared filter can be moved out of the path of the light into the camera for capturing infrared images. The IrDA port 38 can be set to irradiate continuously to function as a light source for the camera 35 when it is in the infrared mode. Thus, the camera 35 can be used when there is little or no ambient light. The use of an IrDA port as a light source for a digital camera and the details of a device to move the infrared filter in and out of the camera path as well adjustments to the auto focus system are disclosed in U.S. patent application with Ser. No. 10/029,968, hereby incorporated by reference.

The lens 36 is preferably a fixed focal length lens with movable lens group to allow auto focus, however, lens 36 could be any type of lens providing for adjustment to focus on different parts of the image received, as will be understood to those skilled in the art.

The characteristics of visible light and near infrared light with respect to focusing are slightly different. Therefore, the auto focus system has two settings; a first setting for capturing images with visual light and a second setting for infrared light.

Standard software for processing, storing and recalling pictures captured with visual light and captured with infrared light is installed on the phone 1. This software may as such be conventional and commercially available. The software is also able to control the refresh rate of the images shown on the display.

Optionally, the phone 1 may also comprise one or two tilt sensors 39 which determine the direction and magnitude of the displacement relative to vertical using the planetary gravitational field. Such sensors could be any of well known types such as those operating with an encoding disk on a freely rotatable shaft connected to a weight, or of the type that uses sphere provided with an asymmetrical weight that floats in a liquid. Alternatively the tilt sensor could by of the gyroscopic type. The signals of the camera the tilt sensors can be combined for generating the motion signal.

The phone 1 in accordance with e preferred embodiment employs two operational modes associated with the use of motion of the phone to generate user input, which throughout this document are referred to as navigation mode and fixed mode. When set to the navigation mode, motion of the phone 1 is used as input, and when displaying an image, the display view is automatically scrolled, zoomed and rotated to follow movements of the holding hand. The navigation mode is activated by pressing the left softkey 9 “Navigate”. Thus, the navigation mode is activated and the functionality of the left softkey 9 changes to “Fixed”. When set back to the fixed mode by pressing the left softkey “Fixed” again, the display view becomes stationary and no longer follows the movements of the hand.

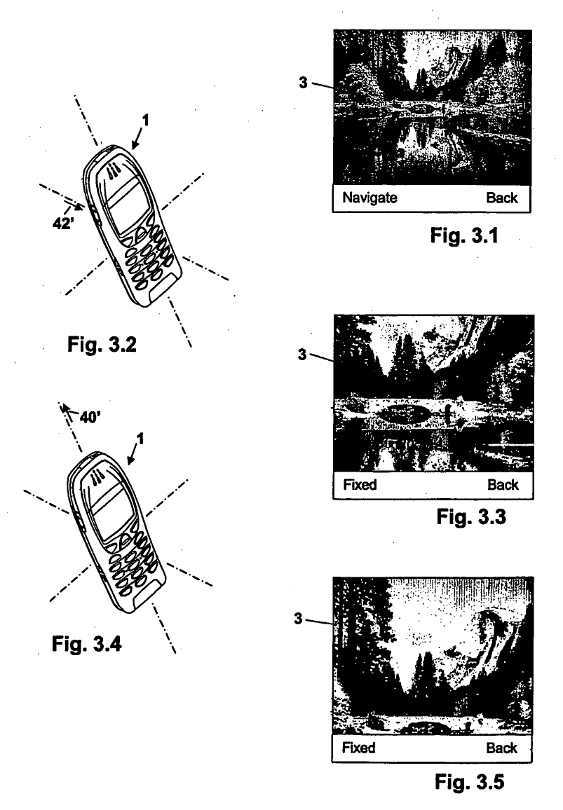

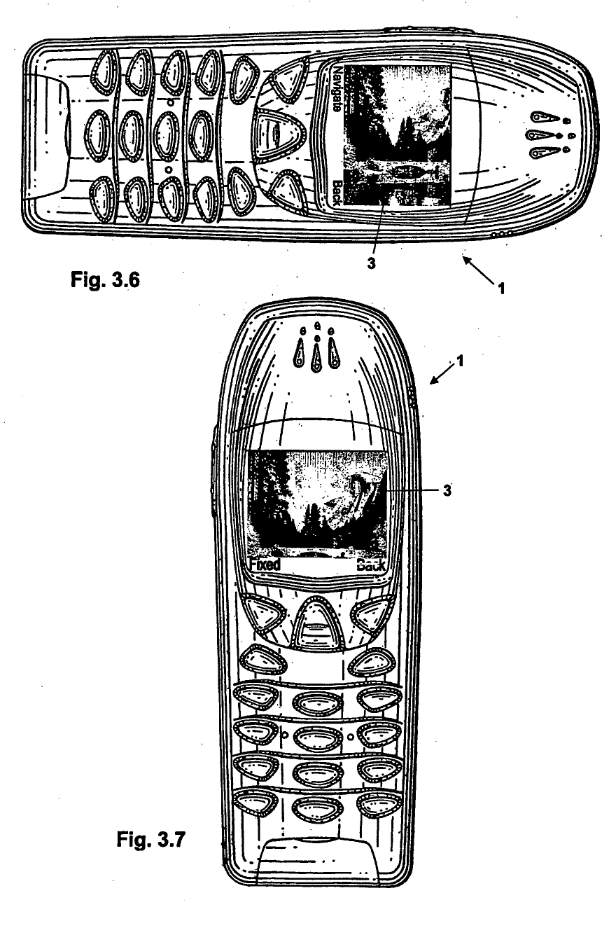

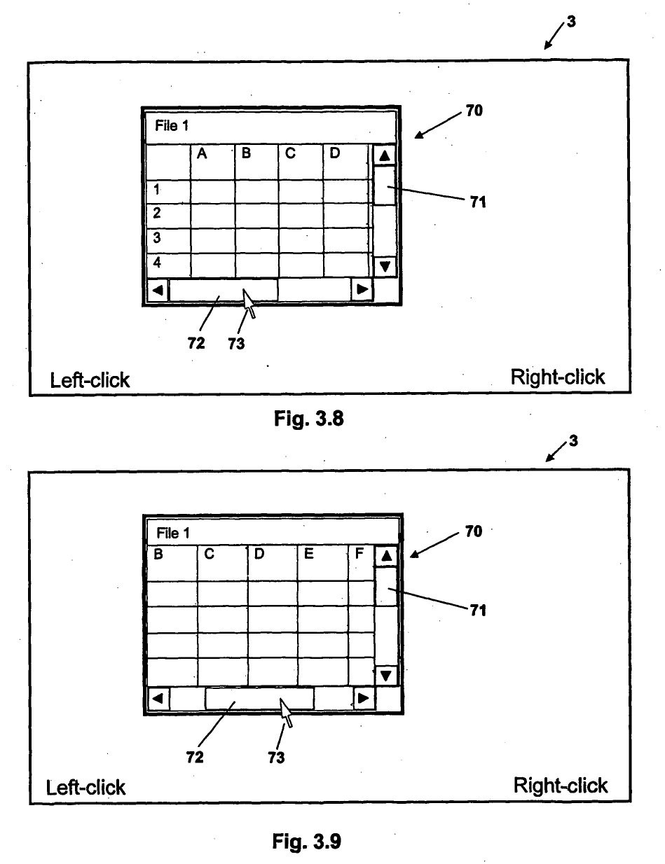

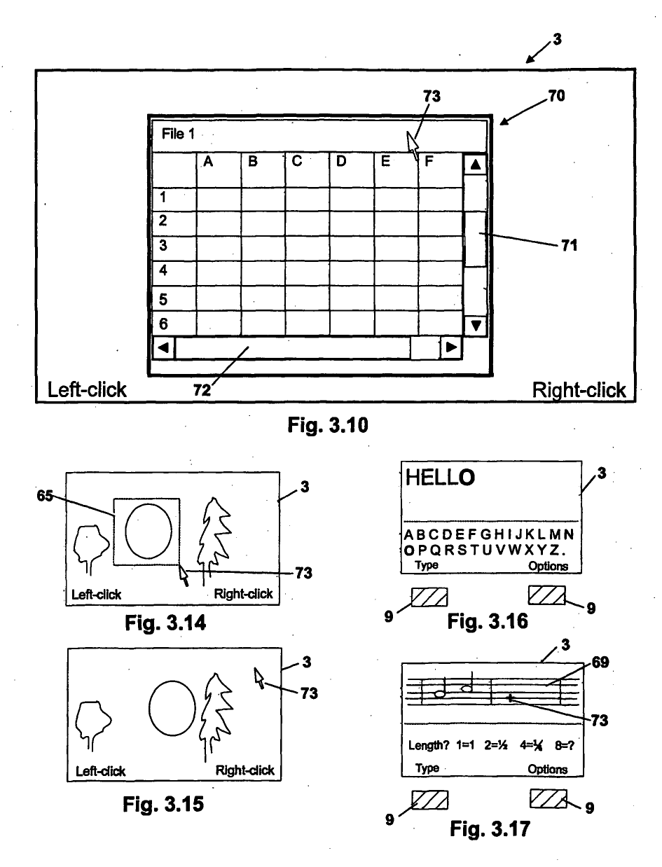

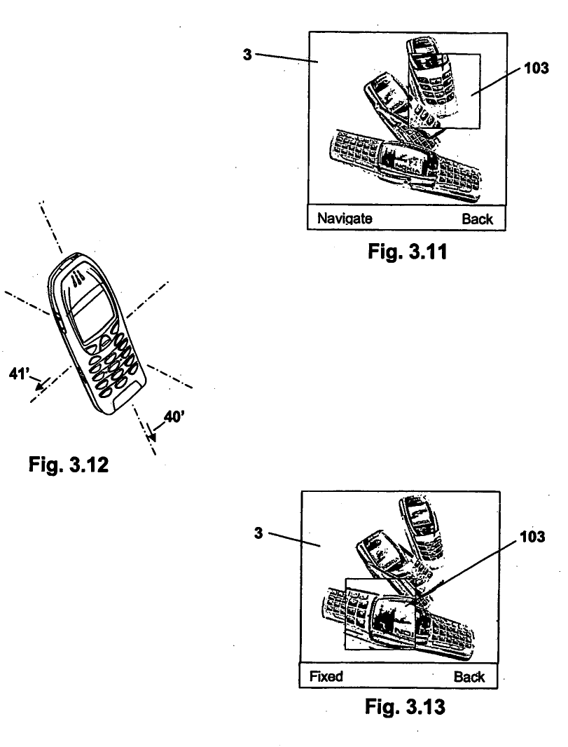

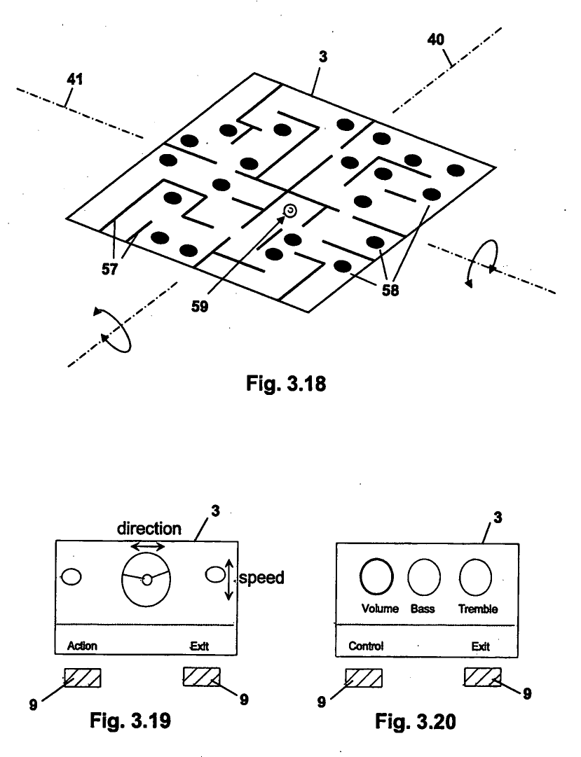

FIG. 3 indicates the relative axes of orientation along which the phone 1 is rotated or translated in order to navigate an image on the display 3. Throughout this document, axis 40 will be referred to as the Y-axis, and motion of the phone in the direction of the Y-axis is in a preferred embodiment used to scroll images in the Y-direction. Similarly, axis 41 will be referred to as the X-axis and motion of the phone in the direction of the X-axis is in a preferred embodiment used to scroll images in the X-direction. Motion in the camera direction measured along the Z-axis 42 is in a preferred embodiment used to control the zoom factor of the images shown on the display 3. Rotation about the Z-axis is used to rotate images shown on the display 3. Though these are the preferred functions assigned with movements along the X-, Y- and Z-axes, any other functionality can be assigned to movement in the direction of these axes or to rotational movement about these axes.

While the scrolling, zooming, and rotation of the display follows the movements of the device, the rate of scrolling/zooming/rotation as well as the amount of scrolling/zooming/rotation need not follow the exact amount of change in position, and can be inverted. As will be discussed below, the control software of the present invention can smooth the movements of the phone to provide a convenient effect on the display.

FIGS. 3.1 to 3.13 show an overview of the operation of the phone 1 to scroll, zoom and rotate images.

With reference to FIG. 3.1, a high resolution image of a holiday snapshot comprising a lake, a bridge and a mountain peak stored in the RAM 17a is shown for viewing on the display 3. The display 3 is too small to show the entire image with sufficient size to appreciate all the details in the image conveniently. The user presses the left softkey 9 “Navigate” to enter the navigation mode. The phone activates the navigation mode and changes the label above the left softkey 9 to “Fixed”. In FIG. 3.2, the navigation process is started when the operator's hand moves the phone 1 along the Z- axis 42 in the direction of arrow 42′ for magnifying the view so that the display 3 shows the central portion of the image with the bridge in an enlarged manner (FIG. 3.3). By moving the phone along the Y-axis 40 in the direction of arrow 40′ the display 3 scrolls the images upwards and the mountain peak above the bridge can be viewed (FIG. 3.5).

In FIG. 3.6 the holiday snapshot is shown in a portrait orientation and can only be properly viewed with the phone in a horizontal position. The user wishes to view the image with the phone in an upright position so that the image will be displayed in a landscape position with respect to the display 3. The user presses the left softkey 9 “Navigate” to activate the navigation mode and rotates the phone a half turn anticlockwise (FIG. 3.7). The movement of the phone 1 creates a series of changing images captured by the camera 35 from which the software on the phone derives a motion signal. Upon detection the rotational movement about the Z-axis the software on the phone rotates the displayed image in the opposite direction, and when the user has completed a half anticlockwise turn the software has rotated the image a half turn clockwise, and the user can conveniently view the image with the phone in an upright position. The image is thus static with respect to the fixed coordinate system in which the phone 1 device is situated.

The settings for the responses to motion of the phone 1 can thus be set in way in which the user perceives the view as that of a static image over which a magnifying window (the display 3) is moved.

FIG. 3.8 shows a display 3 of the phone in a mode in which a graphical user interface is used to command the device. A window 70 containing a scrollable table is displayed on the display 3. Scroll bars 71 and 72 are shown to the right and at the bottom of the table, respectively. A cursor 73 can be moved over the display by moving the phone in the direction of the X- and Y-axes. The left softkey 9 “Left-click” has the same functionality as the left mouse button as known from many windows based graphical user interfaces, namely to select a primary function associated with an object marked by the cursor 73. By clicking, double clicking or holding the left softkey 9 down. The right softkey 9 “Right-click” also has the same functionality as the right mouse button as known from many windows based graphical user interfaces, namely to select secondary functions associated with an object marked by the cursor 73. It is possible to assign the “Left click” and “Right click” to other keys of the phone, but using a similar layout as for the keys of a computer mouse may facilitate user acceptance.

### EXAMPLE 1

The user wishes to scroll the table to the right to view column E. By holding the left softkey 9 “Left-click” pressed and moving the phone to the right along the X-axis the table is scrolled by dragging it with the cursor to the right as shown in FIG. 3.9.

### EXAMPLE 2

The user wishes to resize the window 70. After placing the cursor 73 on the upper bar of the window 70 and while holding the left softkey 9 “Left-click” movement of the phone 1 in the direction of the Z-axis resizes the window 70. Moving the phone towards the user enlarges the window as shown in FIG. 3.10 and moving away from the user reduces the size of the window (not shown).

### EXAMPLE 3

The user wishes to move a part of an image in an image editing program. The part of the image to be moved is marked with a sizable box 65. Holding the left softkey 9 “Left-click” down and moving the mouse by rotating the phone about the X- and Y-axis resizes the box (FIG. 3.14). After sizing the box 65 the left softkey 9 is released and the cursor 73 can be moved freely. The box can be dragged and dropped to the desired position by placing the cursor 71 in the box 65 and holding the left softkey 9 “Left-click” down whilst rotating the phone about the Y- and/or X-axis until the box has moved to the desired position. By releasing the left softkey 9 the boxed is dropped and the cursor 73 can move freely again. Thus, the part of the image in the box is cut from the original position and pasted to the new position.

In the same or manner any object e.g. text in a text editor program, or numbers/text in a spreadsheet can be marked, resized, dragged and dropped “click and drag” with the left softkey.

The most common “gestures” performed by moving the phone and pressing the softkeys are:
point (to place the cursor over an object of the graphical user interface),
left-click (to press and release the left softkey) to select the object which the cursor is placed,
double-click (to press and release a softkey twice in rapid succession) to activate the object that the cursor is placed over,
right-click (to press and release the right softkey) to call up a context-sensitive menu, and
drag (to hold down the left softkey while moving the phone to move the cursor) to move or resize objects.

FIGS. 3.11 to 3.13 show another method of manipulation magnified portion of an image. FIG. 3.11 shows the display 3 with an image of a several advanced type mobile phones. A magnifying window 103 enlarges a portion of the image to allow the user a view with both a good overview and the possibility to view detail in a selected portion of the image. The magnifying window 103 can be moved over the display 3 by holding down the left softkey 9 “Navigate” whilst moving the phone in the direction of arrow 41′ and/or arrow 40′ (FIG. 3.12) to place the magnifying window at the desired position (FIG. 3.13). The magnifying factor of the magnifying window can be changed by moving the phone 1 in the direction of the Z-axis (not shown).

FIG. 3.16 shows another example of the use of the present intention in the form of an application for entering text. In the upper part of the display shows a string of characters already entered. A set of characters that can be entered, in this example the alphabet, is displayed below the upper part of the display. Other character sets could comprise a number set or special signs set, etc.

The functionality of the left softkey 9 “Type” and the right softkey 9 “Options” is shown in the lower part of the display. One of the characters of the character set is marked by bold print. By rotating the phone about the Y-axis 40 the marking moves left or right. By rotating the phone about the X-axis 41 the marking moves up and down. The marked character is added to the string of characters by pressing the left softkey 9 “Type”.

By pressing the right softkey “Options” a scrollable list of selectable menu items is displayed (not shown) comprising: “Clear last character”, “Clear screen”, “Number character set”, “Symbol character set”, and “Exit”, one of the menu items being marked by inverse print. The list can be scrolled by rotating the phone about the Z-axis 41, and the marked menu item is selected by pressing the left softkey 9 “Select”.

FIG. 3.17 shows another example of the use of the present invention in the form of an application for entering musical notes in a stave 69. A cursor 73 (shape changed to a cross for this application) is used to indicate the position where a note is to be entered. By rotating the phone about the Y-axis 40 the cursor can be moved left an right. By rotating the phone about the X-axis 41 the cursor can move up and down.

The cursor is placed above the position in the stave at which a note is to be entered, higher tones are placed higher up in the stave and lower tones are placed lower in the stave. A tone is entered by pressing the left softkey 9 “Type”. After typing a note the application prompts for entering the length of the note by displaying the text “Length? 1=1 2=½ 4=¼ 8=⅛” between the stave and the labels for the softkeys. The note length is entered by pressing the alphanumeric key with the value associated with the desired note length.

By pressing the right softkey “Options” a scrollable list of selectable menu items is displayed (not shown) comprising: “Clear last note”, “Clear stave”, “Enter special notes”, and “Exit”, one of the menu items being marked by inverse print. The list can be scrolled by rotating the phone about the X-axis 41, and the marked menu item is selected by pressing the left softkey 9 “Select”.

FIG. 3.18 shows another example of the use of the present invention in the form of an application simulating a labyrinth game. The player (user of the hand-held device) endeavors to guide a virtual ball 59 through a virtual labyrinth formed by virtual walls 57 on a virtual playing surface past a plurality of virtual openings 58 though which the virtual ball 59 may drop.

The application simulates the effect caused by gravity that tilting a real playing surface out of the horizontal plane has on a real ball, e.g. the virtual ball starts rolling to the lower side of the display 3 when the latter is tilted out of the horizontal plane. Also the effect of gravity on a real ball passing over a real opening is simulated by the application, e.g. the virtual ball drops through the virtual opening when it passes over a virtual opening.

At the start of the game, the display is held horizontally, or any other orientation that the user deems suitable as reference orientation to calibrate the virtual “horizontal” position of the display. The movement of the virtual ball over the virtual playing surface is controlled by moving the phone out of- and back into the horizontal plane by rotating it rotating about the Y-axis 40 and/or the X-axis. The rotational movements are detected from the changes between the succeeding images captured by the camera and translated into changes in speed and rolling direction of the virtual ball.

FIG. 3.19 shows another example of the use of the present invention in the form of an application for controlling another computer game, in this example a car racing simulation. The player (user of the hand-held device) endeavors to “drive” a car around a racing circuit as fast as possible. The application allows the player to control the steering breaking and giving gas functions. The imaginary view on the racing circuit is the main content of the display, but is not shown on FIG. 3.19. The display further shows a steering wheel and rearview mirrors. A race is started by double clicking the left softkey 9 “Action”. The control settings for speed and directions are calibrated and set to zero for the present position and orientation of the phone 1. After an audible start signal the driver is supposed to attempt to follow the displayed racing circuit. The “car” is steered by rotating the phone about the z-axis 42. Rotating the phone clockwise out of the calibrated position about the Z-axis makes the “car” turn right. Rotating the phone further out of the calibrated orientation, make the “car” turn sharper and vice versa. Similarly, rotating the phone anti-clockwise about the Z-axis out of the calibrated position makes the “car” turn left. The speed of the “car” is controlled by tilting the phone 1 about the X-axis 41. Rotating the phone 1 out of the calibrated position in one direction is used to give “gas”. Rotating the phone 1 further out of the calibrated orientation increases the amount of “gas”, and vice versa. The amount of breaking applied to the car is similarly controlled by rotating the phone 1 out of the calibrated position in the opposite direction. The user may select which direction of rotation about the X-axis is used to give “gas”, whereby the breaking direction is always the opposite. Other computer games that can be controlled in a similar manner but using more axes of motion/control include motor bike racing, and helicopter flying. For motorbike racing the factor balance can be included in relation to motion about one of the axes, to produce a very realistic experience, with e.g. steering bar rotation connected to rotation about the Z-axis, giving gas and breaking connected to rotation about the X-axis and balance connected to translative motion along the X-axis. For enhancing the games the capacity of the mobile phone to generate sound via the loudspeaker, in particular a hands-free loudspeaker is used to simulate e.g. motor, and/or propeller sound. The vibrator function (not shown) of the mobile phone can be used to give feedback in connection with shocks and crashes.

FIG. 3.20 shows another example of the use of the present invention in the form of an application for controlling the sound setting of a music player function of the phone. The application allows a user to control volume, bass and treble. The application shows a volume button, a bass button and a treble button on the display 3. The button that is to be manipulated is be marked by a higher line thickness (as shown for the “Volume” button in FIG. 3.20). The marking can be moved to other buttons by rotating the phone about the Y-axis 40. The marked button is manipulated by holding the left softkey 9 “Control” down while rotating the phone about the Z-axis 42. Clockwise rotation of the phone results in an increased setting of the parameter concerned, anticlockwise rotation of the phone results in a decreased setting of the parameter concerned. The application ends by pressing the right softkey 9 “Exit”. Alternatively, the display shows slide control knobs for each of the parameters to be controlled (not shown). The knob that is to be manipulated is be marked by a higher line thickness. The marking can be moved to other knobs by rotating the phone about the Y-axis 40. The marked knob is manipulated by holding the left softkey 9 “Control” down while moving the phone in the direction of the Z-axis 42. Moving the phone in the direction in which the display 3 is facing increases the parameter setting concerned, moving the phone in the opposite direction results in a decreased setting of the parameter concerned.

Another example of the use of the present invention is in connection with another terminal such as a PC (not shown). The motion signal of the phone is transmitted to the PC to control the movement of an object. The object could be a 3-D object displayed on a screen connected to the PC, whereby orientation changes of the phone are used to change the orientation of the displayed object. The orientation of the object on the screen can be completely synchronized with the orientation of the phone. After an initial calibration of the relative positions, e.g. when the phone is upright, the displayed object is also upright. For e.g. presenting a product, the product can be shown as an object on a large screen. To change the orientation of the object the user changes the orientation of the phone by rotating it, and the PC rotates the displayed object in the same way in response to the signal that it receives from the phone.

Another example of using the phone with another terminal, i.e. a workstation or a PC is for moving through an imaginary 3-D space displayed on a screen by e.g. a CAD program. The movements of the phone in the real 3-D world are incorporated in the signal that is sent to the workstation and the PC or workstation translates the signal to movements of the viewing position in the “3-D space” displayed on the screen. Changes in the orientation of the phone are also incorporated in the signal that is sent to the workstation and translated to changes of the viewing, direction in the “3-D space” displayed on the screen. Thus the user can “walk” through an imaginary room by walking around in the real world whilst holding or carrying the phone, and change the viewing direction by pointing the phone in the desired viewing direction. To facilitate this manner of use, the invention could be incorporated in a smaller device that is integrated in a helmet or mounted to another kind of headgear, so that viewing direction can be changed by the user turning his/her head in the desired direction of view.

This manner of controlling the viewing position and the viewing direction can equally well be used for computer games and any other software applications that display a virtual 3-D space on a screen, i.e. to move through and observe a room, or any other place created in a virtual world. Another example of a use of this manner of controlling is game application that guides, i.e. instructs a user to follow a virtual path and checks through the motion signal if the user really travels this path. Such games could be used by a group of users with interactive mobile phones in a suitable open space such as a sports ground.

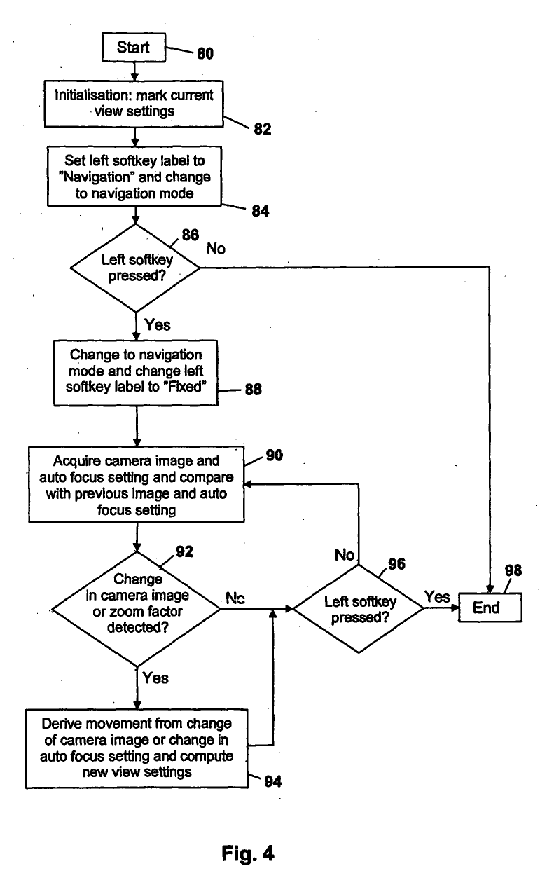

FIG. 4 outlines the software flow diagram for the manipulation of an image as described with reference to FIGS. 3.1 to 3.7. The flow from start 80 to end 98 is performed several times a second in a standard polling process of the processor 18. At the initialization step at block 82, the current view settings are marked. The label above the left softkey 9 is set to “Navigation” in block 84. The status of the left softkey 9 is checked in block 86. If the left softkey 9 is pressed, the system is set to the navigation mode in block 88 and the label above the left softkey is changed to “Fixed”.

At block 90 the camera image and auto focus settings are acquired, stored and compared to the previous readings. If a change in image or in auto focus setting is detected at block 92, the program derives the movement of the phone 1 from the changes in block 94 and computes the new view settings i.e. zoom factor, rotation angle and portion of the image to be displayed. It also instructs the display controller 31 to refresh the display 3 to show the new view and it saves the present camera image as the basis for comparison in the next iteration of the process.

In block 96 the status of the left softkey 9 is checked and if it is pressed the process ends at block 98 until the program is polled again. If the check for the left softkey 9 is negative, the program goes to step 90 and the above process repeats itself.

The program can be set with different response curves for computing the new view setting in response to changes in camera image and/or auto focus setting at block 94. Fine or coarse modes of response can be set by the operator or can be changed dynamically during the time the system is in the navigation mode. With fine response, the display view changes at a relatively slow rate in response to the movements of the phone. With coarse response, the display view changes rapidly in response to the movements of the phone. The response can also be inverted to adapt to user preferences.

The functionality associated with a given type of motion of the phone 1 can be set. Thus, the user can e.g. set the program such that the cursor 73 can be moved up and down by rotation about the X-axis and can be moved left and right by rotation about the Z-axis. Given types of motion of the phone 1 can be associated with functionality that does not relate to the display 3, such as sound settings (e.g. volume and balance) and display settings (e.g. brightness, color balance and contrast).

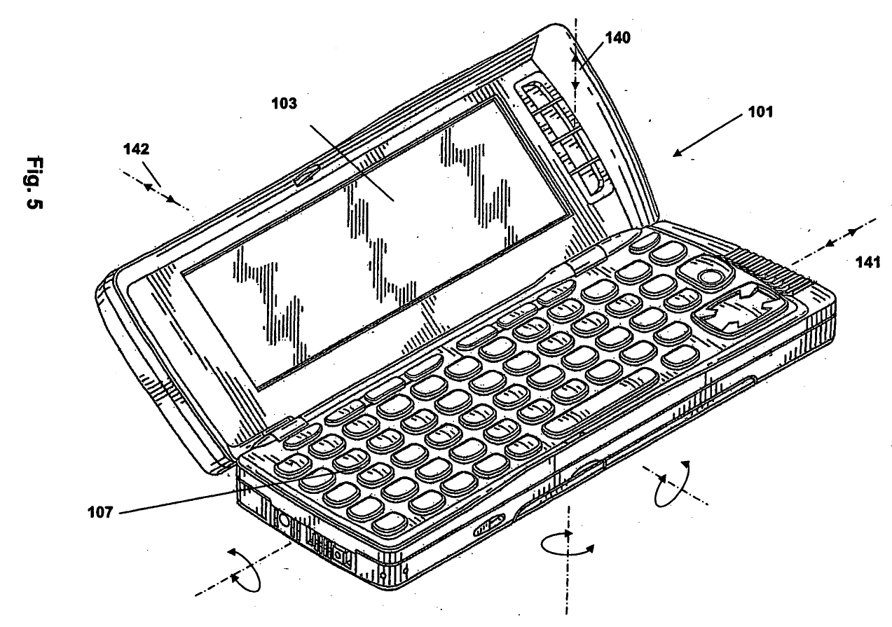

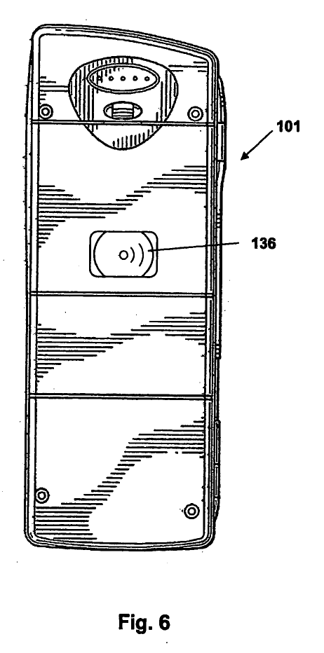

FIGS. 5 and 6 show an alternative preferred embodiment of a hand-held device according to the invention in the form of a communicator 101. The communicator 101 is basically built up in the same way as the mobile phone 1 though with a larger display 103 and a larger keyboard 107. A camera 135 (only lens 136 is shown) is mounted in the back/bottom of the communicator and has the same functionality as the camera in the phone 1. The internal hardware is also build up in the same way as the phone 1, but with increased processing power and a larger memory. Movements of the communicator 101 in the direction of or about the X-axis 141, the Y-axis 140 and Z-axis 142 have the same functionality as in the phone 1.

Although the present invention has been described in detail for purpose of illustration, it is understood that such detail is solely for that purpose, and variations can be made therein by those skilled in the art without departing from the scope of the invention.

Thus, while the preferred embodiments of the devices and methods have been described in reference to the environment in which they were developed, they are merely illustrative of the principles of the inventions. Other embodiments and configurations may be devised without departing from the scope of the appended claims.

1. A hand-held device comprising a processor, a digital camera for capturing motion video or still images, and means for transforming a signal from the camera into a motion signal indicative of the motion of the hand-held device.

2. A hand-held device according to claim 1, further comprising a user interface in which motion of the hand-held device is—through the motion signal derived thereof—used as a user input.

3. A hand-held device according to claim 1, further comprising a display suitable for displaying captured images.

4. A hand-held device according to claim 3, in which motion of a given type of the hand-held device is used to manipulate images shown at least in part on the display, preferably by moving the images in a manner substantially corresponding to the movement of the hand-held device.

5. A hand-held device according to claim 4, in which a given type of motion the hand-held device is used to move, and/or zoom, and/or expand/collapse and/or rotate images displayed on the display.

6. A hand-held device according to claim 5, in which motion substantially parallel to the plane of the display of the hand-held device is used to scroll an image displayed on the display, and/or motion substantially perpendicular to the plane of the display is used to zoom an image displayed on the display and/or rotational motion of the hand-held device is used to rotate an image displayed on the display.

7. A hand-held device according to claim 4, in which the images are images previously captured by the camera.

8. A hand-held device according to claim 4, in which movement of image is inverted with respect to motion of the hand-held device.

9. A hand-held device according to claim 2, in which the user interface comprises a graphical user interface, and wherein motion of the hand-held device is used as an input to the graphical user interface.

10. A hand-held device according to claim 9, in which motion of the hand-held device is used to manipulate an object displayed by the graphical user interface, preferably by moving the object in a manner substantially corresponding to the motion or to the inverted motion of the hand-held device, whereby the object displayed by the graphical user interface can be, an icon, a dialogue box, a window, a menu or a pointer.

11. A hand-held device according to claim 9, in which motion of a given type of the hand-held device is used to move, and/or zoom, and/or expand/collapse and/or rotate objects displayed by the graphical user interface.

12. A hand-held device according to claim 11, in which motion substantially parallel to the plane of the display of the hand-held device is used to scroll an object displayed by the graphical user interface, and/or motion substantially perpendicular to the plane of the display is used to zoom an object displayed by the graphical user interface and/or rotational motion of the hand-held device is used to rotate an object displayed by the graphical user interface.

13. A hand-held device according to claim 2, in which the digital camera is detachable.

14. A hand-held device according to claim 2, in which the digital camera is movable relative to the hand-held device.

15. A hand-held device according to claim 2, in which the means for transforming a signal from the camera into a motion signal derives the motion signal from changes between succeeding images, or parts of succeeding images captured by the camera.

16. A hand-held device according to claim 2, in which the camera has an autofocus system, whereby the focusing setting of the autofocus system is used for detecting movement in the camera direction.

17. A hand-held device according to claim 2, further comprising at least one key, wherein the functionality of a motion type is dependent on the state of the at least one key.

18. A hand-held device according to claim 2, in which rotational motion of the hand-held device about an axis substantially perpendicular to the display results in an inverse rotational movement of the image or graphical user interface object relative to the display, preferably in a manner such that the image or object is static with respect to the fixed coordinate system in which the hand-held device is situated.

19. A hand-held device according to claim 2, in which the motion signal is used to adjust device settings, the device settings preferably comprising sound settings and display settings.

20. A hand-held device according to claim 9, further comprising a keypad with at least a first- and a second key and the graphical user interface comprises a cursor, whereby motion of the hand-held device is used to position the cursor over an object of the graphical user interface and primary functions associated with the object concerned are activated by pressing the first key and secondary functions associated with the object of the concerned are activated by pressing the second key.

21. A hand-held device according to claim 20, in which the functionality of the first key is associated with selection and activation of objects of the graphical user interface, and in which the functionality of the second key is preferably associated with calling up a context-sensitive menu.

22. A hand-held device according to claim 21, in which selection of the object concerned is performed by pressing and releasing the first key, and activation of the object concerned is preferably performed by pressing and releasing the first key twice in rapid succession.

23. A hand-held device according to claim 21, in which moving or resizing of the object concerned is performed by holding down the first key while moving the hand-held device to move the cursor.

24. A hand-held device according to claim 20, in which the first key and the second key are softkeys whereby the current functionality of the softkeys is shown in the display, preferably in dedicated fields of the display.

25. A hand-held device according to claim 24, in which the first key is placed below the display on the left side of the latter, preferably proximate to lower edge of the display, and the second key is placed below the display on the right side of the latter, preferably proximate to lower edge of the display.

26. A hand-held device according to claim 1, further comprising at least one gravity based tilt sensor, and whereby the signal from the at least one tilt sensor is used in combination with the signal from the camera for creating the motion signal.

27. A hand-held device according to claim 26, wherein a tilt sensor is associated with the X-axis and/or a tilt sensor is associated with the z-axis.

28. A hand-held device according to claim 27, wherein the signal form the at least one tilt sensor is used to determined the absolute orientation of the handheld device relative to the direction of the gravitational pull.

29. A hand-held device according to claim 1, further comprising means for sending the motion signal to another terminal via cable, infrared waves or radio frequency waves.

30. A system comprising a hand-held device according to claim 29 and a terminal capable of displaying imaginary three-dimensional objects on a two-dimensional screen, said terminal comprising means to change the orientation of the displayed object in response to signals received from the handheld device, whereby orientation changes of the hand-held device are translated to corresponding orientation changes of the displayed object.

31. A system according to claim 30, in which position changes of the handheld device are translated to position changes of the displayed object.

32. A system comprising a hand-held device according to claim 29 and a terminal capable of displaying an imaginary three-dimensional space on a two-dimensional screen, said terminal comprising means to change the viewing position in the imaginary three-dimensional space in response to signals received from the handheld device, whereby positional changes of the hand-held device are translated to corresponding changes in the viewing position.

33. A system according to claim 30, in which orientation changes of the handheld device are translated into corresponding changes in the viewing direction in the imaginary three-dimensional space.

34. A method for creating user input for a hand-held device that has a processor, a user interface and a digital camera for capturing motion video or still images comprising the steps of:
determining motion of the hand-held device from the camera signal;
using the determined motion of the hand-held device as an input for the user interface.

35. Use of a digital camera for capturing motion video or still images of a hand-held device that has a processor to produce a motion signal indicative of motion of the hand-held device.

36. A hand-held device comprising a processor, means for sensing motion of the hand-held device, a display, a keypad with at least a first- and a second key, a graphical user interface with objects and a cursor, and means for transforming the sensed motion of the handheld device into a signal suitable for moving the cursor over the display.

37. A hand-held device according to claim 36, in which motion of the hand-held device is used to position the cursor over an object of the graphical user interface and primary functions associated with the object concerned are activated by pressing the first key and secondary functions associated with the object concerned are activated by pressing the second key.

38. A hand-held device according to claim 37, in which the functionality of the first key is associated with selection and activation of objects of the graphical user interface, and in which the functionality of the second key is preferably associated with calling up a context-sensitive menu.

39. A hand-held device according to claim 38, in which selection of the object concerned is performed by pressing and releasing the first key, and activation of the object concerned is preferably performed by pressing and releasing the first key twice in rapid succession.

40. A hand-held device according to claim 38, in which moving or resizing of the object concerned is performed by holding down the first key while moving the hand-held device to move the cursor and the object concerned in unison therewith.

41. A hand-held device according to claim 36, in which the first key and the second key are softkeys whereby the current functionality of the softkeys is shown in the display, preferably in dedicated fields of the display.

42. A hand-held device according to claim 41, in which the first key is placed below the display on the left side of the latter, preferably proximate to lower edge of the display, and the second key is placed below the display on the right side of the latter, preferably proximate to lower edge of the display.

43. A hand-held device according to claim 36, in which said means for transforming motion of the handheld device into a signal suitable for moving the cursor over the display comprises a tilt sensor and/or an image capturing device and/or an accelerometer.

44. A hand-held device according to claim 43, in which said image capturing device is a motion video or still image digital camera.

45. A hand-held device according to claim 36, further comprising means to transform a signal from the camera and/or tilt sensor and/or accelerometer into a position signal for the cursor.

46. A hand-held device according to claim 45, in which said means for transforming a signal from the camera into a motion signal derives the motion signal from the changes between succeeding images, or parts of succeeding images captured by the camera.

47. A hand-held device according to claim 44, in which the camera has an autofocus system, whereby the focusing setting of the autofocus system is used for detecting movement in the camera direction.

48. A hand-held device according to claim 36, in which the graphical user interface includes one or more of the following object types: icons, dialogue boxes, windows, menus, pointers.
